(19) United States
(12) Patent Application Publication
(10) Pub. No.: US 2017/0006082 A1
(43) Pub. Date: Jan. 5, 2017

(54) Software Defined Networking (SDN) Orchestration by Abstraction

(71) Applicant: Nimit Shishodia, London (GB)

(72) Inventor: Nimit Shishodia, London (GB)

(73) Assignee: Nimit Shishodia, London (GB)

(21) Appl. No.: 14/295,087

(22) Filed: Jun. 3, 2014

(51) Int. Cl. H04L 29/08; H04L 29/06; H04L 12/26

(52) U.S. Cl. CPC H04L 67/025; H04L 43/14; H04L 67/1002; H04L 67/36; H04L 43/045; H04L 63/1416; H04L 63/20; H04L 63/0263; H04L 63/1441

(57) ABSTRACT

An orchestrator is software appliance comprising of various Software Defined Networking (SDN) applications. The invention is configured on northbound of the SDN controller. It allows dynamic provisioning of network services i.e. monitoring, design, policy implementation, simulation, automation, Intrusion Detection & Prevention (IDP) and Quality of Service (QoS).

### BACKGROUND

Field of Invention

This invention relates to the field of computer networking. In recent years, the evolution of Software Defined Networking (SDN) has changed the way industry perceives networking. SDN, a new approach to networking, decouples the control plane from the networking devices, centralizing them in a controller and allows a programmatic control in the controller. SDN is three-tier architecture (FIG. 1), the 1st tier consists of control applications, which are northbound to the controller, 2nd tier is the controller and the 3rd tier consists of packet-forwarding open-flow switches. An orchestrator resides in the application layer determines and sends control instructions to the controller. Based on the control instructions, controller modifies the flow table inside the switches using Open-flow protocol. The invention refers to a set of multiple control instructions, delivering several networking functions using a controller, thus establishing the SDN orchestration.

Challenges

The challenges of traditional networking can be solved by the invention. The areas in which the invention claims to bring innovation by disruption are:

1) Network Monitoring: In a traditional multi-vendor-networking environment, the devices need to be configured and monitored by separate systems from these vendors. These systems do not provide abstracted statistics (i.e. abstracted network bandwidth utilization) and also lacks the self-healing capabilities for the simple hardware level faults. Traditional monitoring system lacks the automation capabilities in case of network failure and relies upon manual intervention. The invention claims to provide an abstracted network performance matrix and foster auto-healing capabilities in an event of failure.

2) Network Design: In traditional networking, the implementation process comprises of converting a paper drawn design in to configurations upon multiple vendor devices to achieve design objectives. Although the design is abstract, but implementation is done using distributed systems, creating discrepancy between the two. And there are no measures to simulate the design in a pre-production environment. The invention claims to provide an abstracted network design platform, with capability to test the network design in a pre-production virtual environment and can then implement the design in a production environment.

3) Change Control: Making changes in conventional network systems are considered as risk prone task, due to lack of simulation and testing capabilities. An untested change can cause major disruption in the live network services. The invention claims to provide an abstracted environment, which can simulate true copy of production environment and allow the user to simulate the changes prior to deployment, thus reducing the risk of failure.

4) Security: While designing the architects determine the enterprise security strata in an abstracted way. However, this security model is provisioned by statically configuring security feature per box in a distributed manner. Thus making the model less agile, creating redundant and non-compliance security policies, leading to security loopholes. Enterprises spends lots of money, to scan these loopholes, remove redundancy and making security policies more complaint to the standards. However, as claimed by the invention, this problem will never arise with a centralized security rule base, which can be dynamically provisioned on demand basis.

In traditional IDP systems, the IDP device is statically provisioned in-line with the firewall. Upon threat detection, IDP device alerts the users and policies needs to be created on the firewall to block the attack. The invention can dynamically provision IDP as a service anywhere in the data plane. Upon threat detection, it can auto-create firewall policies, check the compliance and automatically implement to block the attack.

5) Quality of Service: Traditionally, Quality of Service in a path needs to be statically configured on the intermittent devices, leading to complex process for new QoS service creation, making network convergence more difficult. Dynamic QoS policies based on traffic pattern is very hard to achieve in existing model. The invention claims to auto identify the best paths based on the calculated costs and provision them dynamically, without configuring policies device by device.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to an orchestration framework for controlling the interaction between interconnected open-flow devices in a coordinated fashion and deliver a networking function, serving to a business purpose.

A first aspect described herein provides a method for dynamically monitoring the control and the data channel utilization in a SDN environment. Being control and data channel logically separated to each other, it is imperative to monitor these channels. In event of any exceeding threshold value for these channels, the orchestrator should be able to generate alert signals, prompting the user to take action.

The Second aspect described herein provides a tool to create dynamic network designs, with the network services defined. The tool will then simulate those designs into a virtual environment and also should be able to deploy that design in a live environment, upon physically interconnected open-flow devices.

The third aspect described herein provides a method for managing dynamic management policies and settings in an orchestration framework for connected OpenFlow devices. A management policy that governs the interaction between the OpenFlow devices may be maintained, and the management policy may be applied in response to receipt of a request, via the orchestration framework, from one OpenFlow switch to perform network connectivity with another OpenFlow switch.

A fourth aspect described herein provides a method for real-time traffic analysis to scan security vulnerabilities and threat detection. The traffic is scanned against the pre-determined threat signature. As the new threats keep on evolving on daily basis, the signature database can be updated via means of Internet. At the time of this writing Heart bleed Open SSL attack became very popular. Upon anomaly detection, the method will auto-create a firewall policy to block the attack. The module is capable of detecting heart bleed attack and auto-create firewall policies to block the attack, with no human intervention.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 depicts an illustrative SDN 3 Tier Architecture that may be used in accordance with one or more illustrative aspects.

FIG. 2 illustrates the Dashboard open flow Module with one or more aspects.

FIG. 3 illustrates the Canvas Module with one or more aspects.

FIG. 4 depicts the process of flow Control open flow module with one or more aspects.

FIG. 5 illustrates the process of flow Netlyzer open flow Module with one or more aspects.

FIG. 6 illustrates the process of flow Flow rector open flow Module with one or more aspects.

### DETAILED DESCRIPTION OF EXEMPLARY EMBODIMENTS

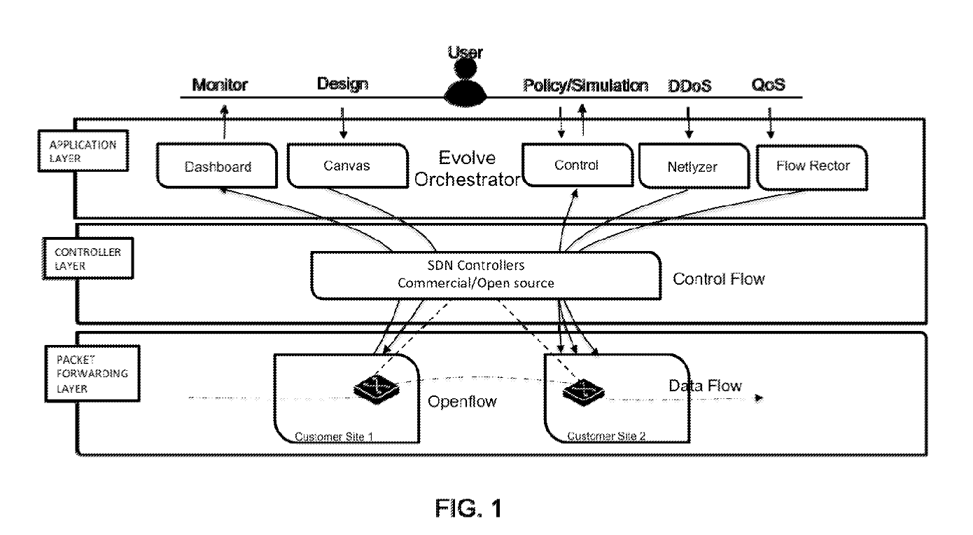

With further reference to [FIG. 1] The SDN architecture consists of three layers namely Application layer, Control layer and packet forwarding layer.

The application layer is a virtual layer where users can Monitor the network, Design, Simulate and automate the network activities. The overall process is further described in detail as follows.

Dashboard is a networking monitoring environment, which monitors the overall network and data health status.

Canvas is a designing tool, which allows users to design and create network topologies. This also provides users and option to save and retrieve the create topologies to simulate them in virtual environment.

Control helps users in simulating the physical network in virtual environment and testing the designated parameters on it before pushing it to the live production environment.

Netlyzer helps users to select their own security system with in their network to continuously monitor, identify and prevent security threats like DDoS attacks.

Flow Rector helps users to control the data flowing throughout the network with the help controller as per user defined and the analyzed flow metrics in the aggregated path.

The control layer acts as a communication platform between application layer and data flow layer and controls the data flow inside the data plane.

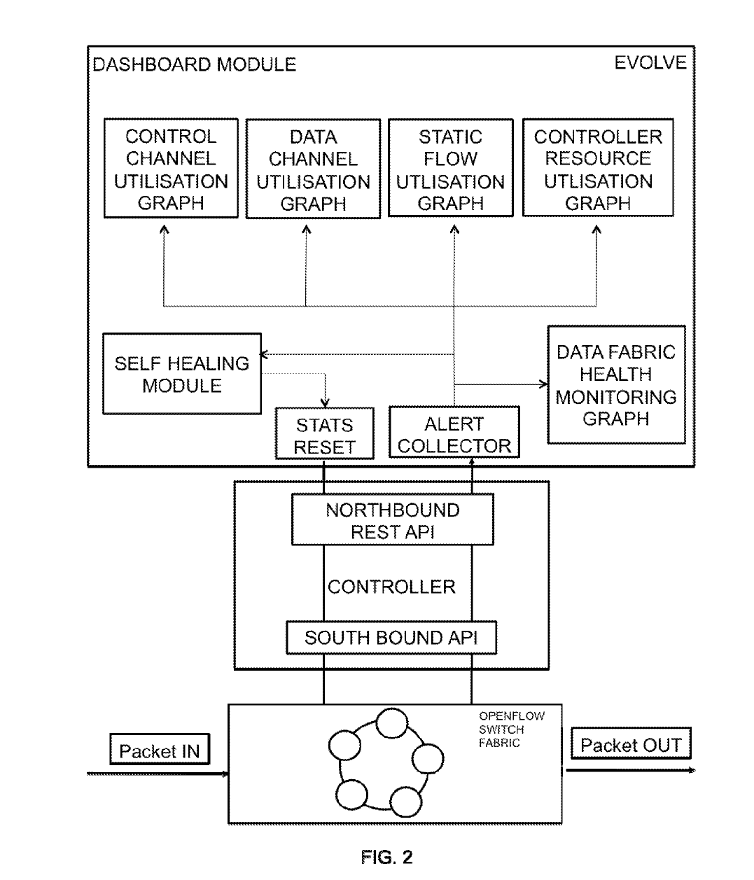

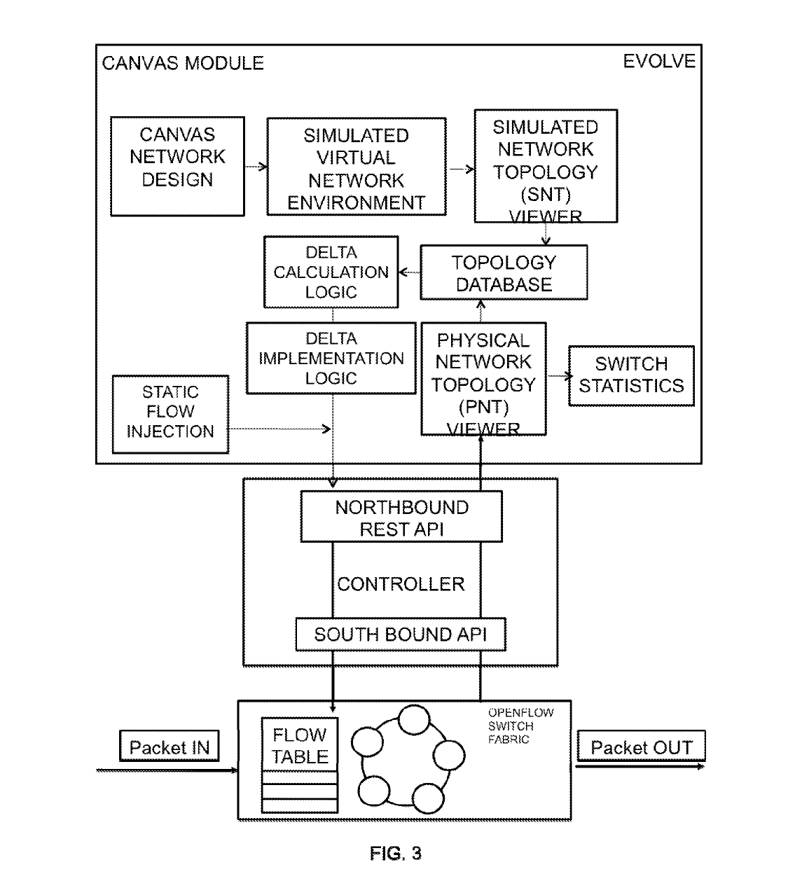

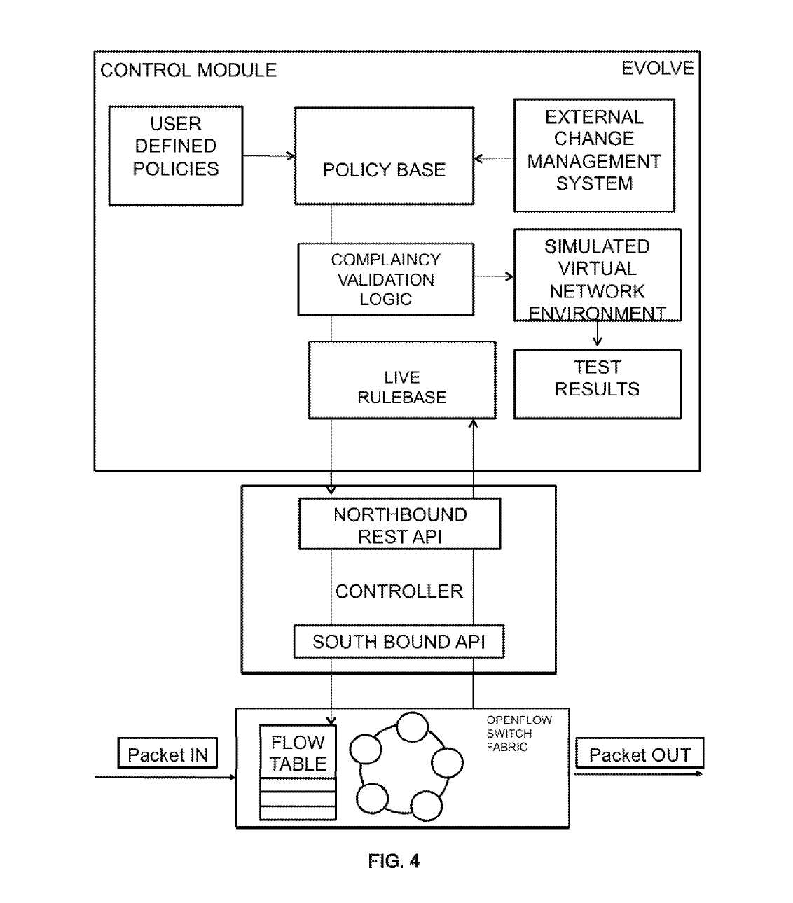

The packet-forwarding layer is a data flow layer, which consists of all physical network devices, which includes switches, routers and hosts etc.

[FIG. 2] Shows a high level architecture of illustrative software defined network monitoring system. The dashboard module collects, calculates and monitors set of parameters and presents them visually. They are discussed in detail as below. The dashboard gathers utilization graph from control channel, data channel, and controller resource utilization and monitors regularly the network's data fabric health. The module continuously reads the network state from the controller and in case of any discrepancy in the flow data; the information is passed to the self-healing module. The self-healing module of the said orchestrator resets the port of the particular switch, which is receiving the errors. The orchestrator receives the information about the network, converts it into visual data and presents it to the user.

[FIG. 3] Shows the architecture of canvas, which may help in user in creating and designing a new network and policies associated with it. The visual network design consisting of switches, hosts and policies between them is converted into a python code and in turn is implemented in Mininet to create a simulated network topology. This helps users in simulating the network in virtual environment prior to its deployment in physical network. The depicted delta calculation module may be used to identify the difference between the physical network topology and the topology, which is created by the user. The design phase also consists of abstracted topology viewer, which might help user to identify the port status of a particular switch, and they're by helping the user in identifying the network connections to every detail. The network visualizer also might help user in creating static flows in the switches across the network by collecting the input from user upon request and collecting it into required instruction format before sending instructions to the controller to install flows on respective switches.

[FIG. 4] Gives an illustrative description of the control module, which is part of the SDN orchestrator. The control module collects the input from user, converts it into required format and pushes it into the database, which is called as the policy base. The input or policies created by the user are check against compliance logic for the validation. In this case, the compliance logic is the duplication of existing rule or policy. The control module also gives user an option to test the policy in a simulated environment, there by reducing the risk by a great margin. The policy base is capable of extracting relevant data from external change management system like Microsoft excel, work etc. The extracted data is automatically converted into a policy and presented to the user after adding it into the database.

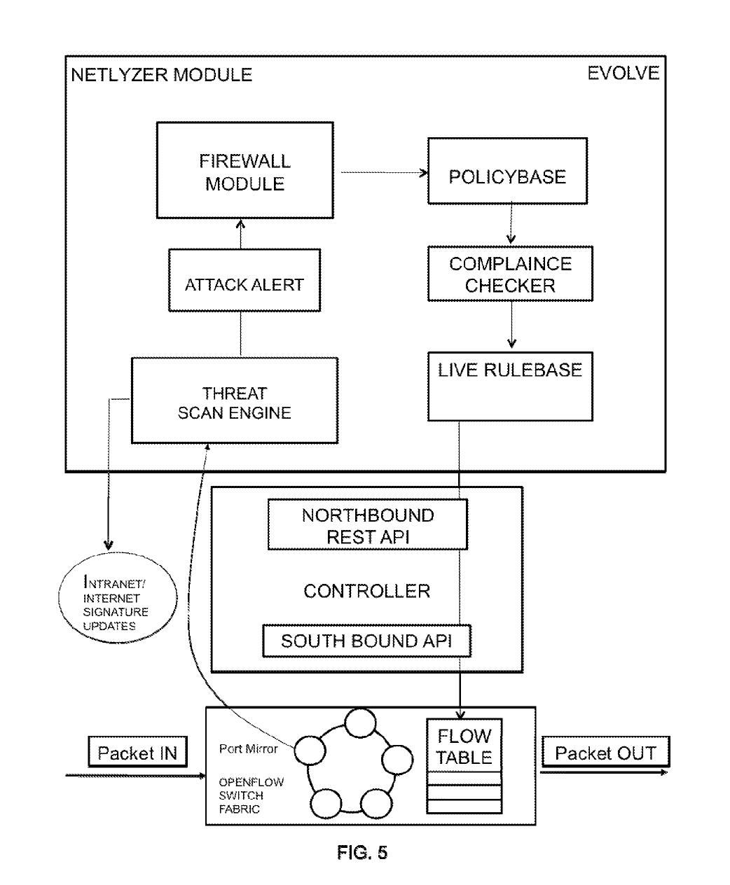

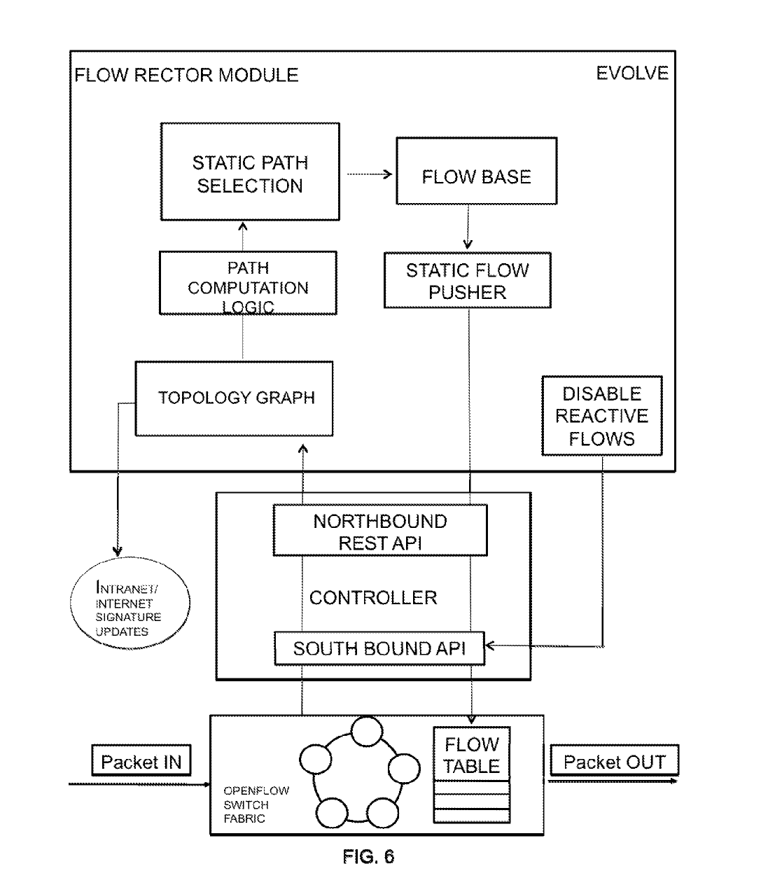

The test results from the simulated environment are compared with the real time data and upon the satisfaction of the user; making it a rule might push the policies into the live production network there. The rule is sent as an instruction to the controller, which in turn installs flow tables on the switches to allow or deny the traffic as per the rule created.

[FIG. 5] Shows the architecture of Netlyzer module, which is an automatic signature, based SDN IDS/IPS. The live traffic data flowing through the network is port mirrored and passed to the orchestrator, which conducts the deep packed analysis on the packets flowing through the network and identifies threats based on the predefined signatures. The identified threats are converted into required formats and firewall policies are created based on the information. The policies automatically pass through the compliancy logic and final a firewall rule is created automatically based on the IDS signature. The automatically created rule is pushed into the live network as static flows on the switches using the controller. The attack engine performs the deep packet analysis and decides the alerts, which needs to be forwarded to the firewall creation module.

[FIG. 6] Depicts the diagrammatic description of the flow rector module, which provides dynamic quality of service to the application data. The particular hosts for which path is to be computed is received as an input from the user. The path computation logic extracts complete state of network and interlinks through the state table, which is created from the physical network. Several paths are identified between the mentioned hosts using the state table and extracted costs between the hosts. The orchestrator considers several factor while determining the paths between the hosts. The costs might include hop count, bandwidth, and average number of flows, average bytes of data flowing through the network etc. This presents user an opportunity to select the best path between the identified hosts. The mentioned orchestrator converts the path into respective flows on individual switches and makes calls to the controller to install flows on the respective switches. Once the flows on the individual switches are made, an overall path between the designated hosts is created. The path creation might include the module, which disables all the reactive flows handled by the controller and allowing only the static flows created by the user.

The flow rector module continuously monitors all the paths and the costs associated with it. An option is provided to the user to either enable or disable the traffic-engineering feature. The traffic engineering is enabled the monitored costs are compared continuously to identify the best path between to designated hosts. Once the identified best path is different from the existing path, the flow rector module deletes the path by automatically deleting the flows existing on individual switches and creating new flows which in turn creates new path altogether.

Listing of Claims.

What is claimed is:

1. A method for Network application orchestration, comprising:
A Web-based suite of software tools to facilitate monitoring, dynamic network design, provisioning, simulation and automation, Intrusion Detection and Prevention (IDP) and Quality of Service (QoS), by leveraging the power of Software-defined Networking (SDN);
Communication with SDN controller to fetch and send data and instructions;
Web interface to display and collect relevant monitoring data to and from the user;
Automated switch health monitoring and healing;
A database to store the data exchanged between the user and said suite of tools;
A database to store the data exchanged between said suite of tools and the SDN controller;
Time based automatic calls to the SDN controller;
Web based interactive network topology viewer;
Web based interactive network designer;
Software based load balancer module for UDP, TCP and ICMP flows;
Extracting policy information from digital documents or external order systems;
Creating static policies to allow communication between network devices;
Dynamic simulation of physical network in a virtual environment;
Automatic security policy creation and implementation based on deep packet analysis on the traffic data;
Automatic best path selection and quality of service for intelligent traffic steering;

2. The method according to claim 1, wherein said step of display of network monitoring statistics, automatic switch health monitoring and healing, make calls to the controller to fetch and compute control channel utilization, data channel utilization, switch fabric health, packet flow health, controller compute utilization and display it graphically to the user.

3. The method according to claim 1, wherein said step of automatic switch health monitoring process comprises
Scanning all the ports of all the open-flow enabled switches in the network
Scanning all the ports of a specific switch in the network
Scanning a specific port on a specific switch
Analyzing information based on the port status and data health
Taking decision on whether to re initialize the port or not based on the health of packets flowing through the network.

4. The method according to claim 1, wherein said step of database to store the data exchanged between user and said suite of tools makes use of relation database to store the input taken by the user in the format of a firewall policy.

5. The method according to claim 1, wherein said step of database to store the data exchanged between the suite of tools and controller makes use of relation database to store the instructions issued to the controller over rest API and policies currently being implemented in the controller.

6. The method according to claim 1, wherein said step of time based automatic calls to controller, creates policies and sends out instructions over rest API based on the time specified by the user over web interface.

7. The method according to claim 1, wherein said step of abstract view of network topology, fetches information about open-flow enabled nodes and their internal links in the network over controller's Rest API and displays it to the user as an interactive network diagram.

8. The method according to claim 1, wherein said step of abstract view of network topology, facilitates view of overall port connection status of all or individual switches using interactive network viewer.

9. The method according to claim 1, wherein said step of abstract view of network topology, facilitates interface to collect information from user and convert it into specific instructions and send them over rest API calls to create static flows and paths in the network.

10. The method according to claim 1, wherein said step of network design, lets users to design and create dynamic networks. The said tool converts this visual design into a python script and executes it in a Mininet instance over secure shell connection to create a virtual network and assign the policies designated during the design phase.

11. The method according to claim 1, wherein said step of network simulation, gives users a abstract view of the actual network and allows them to implement the same network in virtual environment with one click provisioning.

12. The method according to claim 1, wherein said step of network simulation, creates a state table of the network from the network nodes and their link status. A python script is generated based on the constructed network state table, which is executed over a secure shell connection to create a virtual network using Mininet. This allows users to test policies in virtual environment prior to deployment.

13. The method according to claim 1, wherein said step of policy extraction reads the relevant information from the digital documents and creates policies automatically and writes them to the said user input database. The policy can relate to static flows, firewalls etc.

14. The method according to claim 1, wherein said step of automatic policy creation based on deep packet analysis, uses signature based packet analysis for intrusion detection. The said suite of tools extracts the relevant information from the IDS system to create a firewall policy to block any further attacks from that particular user.

15. The method according to claim 14, creates specific policies for specific kind of identified attack and send the instructions over rest API to the controller to install flow tables on the respective open-flow enabled switches to block the traffic from the source of attack.

16. The method according to claim 1, wherein said step of software defined load balancing lets users to define the VIPs (virtual IP addresses), pools and the pool-member IP-addresses. These are assigned to the loadbalancer module.

17. The method according to claim 1, wherein said step of software defined load balancing uses round robin policy among servers to balance the load from the VIP to the members in the pool by sending appropriate instructions to the controller.

18. The method according to claim 1, wherein said step of automatic best path selection, collects input from user and fetches the flow, bandwidth and node links in the network over controller rest API and identifies the best path between two nodes specifying the costs which led to the identification of these paths.

19. The method according to claim 18, identifies various parameters which can act as cost from the existing flows, aggregates them and calculates the average cost to identify the probable best paths. Upon confirmation from the user, the suite of tools creates static flows and sends the instructions automatically over the controller rest API.

20. The method according to claim 1, wherein said step of traffic engineering, continuously monitors the paths between the specified nodes and upon failure of an existing path or availability of a better path deletes the existing flows and creates new flows on the switches using the controller rest API.
